(19) United States
(12) Patent Application Publication
(10) Pub. No.: US 2025/0363389 A1
(43) Pub. Date: Nov. 27, 2025

(54) FAULT CLASSIFICATION AND LOCATION OF A PMU-EQUIPPED ACTIVE DISTRIBUTION NETWORK USING DEEP CONVOLUTION NEURAL NETWORK (CNN)

(71) Applicant: KING FAHD UNIVERSITY OF PETROLEUM AND MINERALS, Dhahran (SA)

(72) Inventors: Md SHAFIULLAH, Dhahran (SA); Md Nazrul Islam SIDDIQUE, Dhahran (SA); Mohamed A. ABIDO, Dhahran (SA)

(73) Assignee: KING FAHD UNIVERSITY OF PETROLEUM AND MINERALS, Dhahran (SA)

(21) Appl. No.: 18/669,711

(22) Filed: May 21, 2024

(51) Int. Cl. G06N 3/0985; G06N 3/045; G06N 3/0464; H02J 3/00

(52) U.S. Cl. CPC G06N 3/0985; G06N 3/045; G06N 3/0464; H02J 3/0012

(57) ABSTRACT

A device and method for fault management for an electric power distribution network incorporating intermittent generation sources. The method involves configuring multiple hyperparameters for a series of Convolutional Neural Networks (CNNs). A first CNN is trained using current signal imagery from phasor measuring units (PMUs) during fault conditions to classify faults. A second CNN is trained with signal images from PMUs captured during pre-fault and fault cycles for identifying fault sections. Similarly, a third CNN is trained using these images to determine the exact fault location. Once trained, the CNNs are employed sequentially. The first CNN classifies the fault, the second detects the fault section, and the third ascertains the fault location. Subsequently, a comprehensive fault management strategy is deployed.

### STATEMENT REGARDING PRIOR DISCLOSURE BY THE INVENTORS

Aspects of this technology are described in “Fault classification and location of a PMU-equipped active distribution network using deep convolution neural network (CNN)”, published in Electric Power Systems Research, Volume 229, 110178, which is incorporated herein by reference in its entirety.

### STATEMENT OF ACKNOWLEDGEMENT

Support provided by the SDAIA-KFUPM Joint Research Center for Artificial Intelligence (JRCAI) at the King Fahd University of Petroleum & Minerals (KFUPM), Saudi Arabia, under project no. JRCAI-RG-01 and King Abdullah City for Atomic and Renewable Energy (K.A.CARE) is gratefully acknowledged.

### BACKGROUND

### Technical Field

The present disclosure is directed to the field of fault diagnosis within power distribution networks.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Power distribution networks are fundamental to the delivery of electricity from transmission systems to end-users, encompassing residential, commercial, and industrial sectors. The expansion and increasing complexity of these networks, combined with a growing demand for electrical power, have heightened their susceptibility to faults. Faults can be induced by various factors, including, but not limited to, adverse weather conditions, insulation failures, aging infrastructure, and operational discrepancies. For example, the strong winds associated with the storm can cause tree branches to break and fall onto the overhead power lines. Such physical contact disrupts the electrical insulation of the lines, creating a pathway for electrical current to ground or between phases, leading to a short circuit or ground fault. In another example, lightning strikes, a common occurrence during thunderstorms, can induce over-voltages in the power lines. If the surge exceeds the insulation's withstand capacity, it can cause insulation failure. This results in faults that can either be phase-to-phase, phase-to-ground, or a combination, severely affecting the network's integrity and reliability. These faults pose significant challenges, not only causing disruptions in power supply but also leading to considerable economic losses and undermining the reliability of the power distribution system.

Fault diagnosis in power distribution networks is imperative for promptly identifying and localizing faults to facilitate swift restoration efforts. However, the distinct characteristics of distribution networks, such as their non-homogeneity, the presence of multiple laterals, phase unbalance, diverse conductor configurations, load uncertainty, and variable fault resistance, complicate the diagnostic task. The integration of distributed generation (DG) sources, including wind and photovoltaic (PV) systems, further complicates fault diagnosis by transforming the networks from passive to active systems with bidirectional power flows. The stochastic nature of DG poses additional challenges to conventional protective devices and necessitates a reevaluation of existing protection schemes and fault diagnosis techniques.

Existing techniques for fault diagnosis can be broadly categorized into three groups. First, impedance-based approaches, second, high-frequency components, and third, traveling-wave-based techniques. The knowledge-based methods can also be implemented for fault diagnosis. Each of these methodologies has inherent limitations that constrain their effectiveness. For example, impedance-based methods, while simpler to implement, have constraints on the complexity of distribution networks and may yield inaccurate estimations in the presence of laterals. Traveling-wave-based methods demand high sampling rates, extensive communication infrastructure, and complex data synchronization, making them less feasible for widespread application. Knowledge-based methods leverage the wealth of data provided by intelligent devices within the network for fault diagnosis. However, they face challenges related to the integration of DG and the management of data uncertainties.

The existing techniques reveal several machine learning techniques employed for fault diagnosis, including Support Vector Machines (SVM), k-nearest neighbors, decision trees, Convolutional Neural Networks (CNN), fuzzy logic systems, and artificial neural networks. Despite achieving high accuracy in fault classification, these methods often fall short in accurately pinpointing fault locations, particularly in large-scale networks or networks integrated with DG sources. Moreover, the impact of DG on fault diagnosis remains inadequately explored in existing research, and there is a notable absence of methodologies that simultaneously consider DG uncertainties, load demand fluctuations, and the uncertainties associated with fault information, such as fault resistance and inception angle.

Each of the aforementioned disclosures suffers from one or more drawbacks hindering their adoption. Fault diagnosis in distribution networks suffers drawbacks, particularly, in accurately determining fault locations and addressing the complexities introduced by the integration of DG sources. Many of the current methods rely heavily on feature extraction, adding complexity to the diagnosis process, and do not adequately consider the uncertainties associated with load demand and fault information. Furthermore, there is a lack of real-time simulation modeling of feeders, which could enhance the accuracy and performance of fault diagnosis methods.

Therefore, there remains a need for a comprehensive and integrated approach that accounts for the critical factors affecting fault diagnosis accuracy and reliability in distribution networks.

Further, the aforementioned conventional technologies offer various methods for managing EV charging and ensuring grid stability. However, they all have certain limitations. Centralized control methods are susceptible to communication disruptions and require significant infrastructure investment. Decentralized control methods, while mitigating communication dependence, may not always be effective in achieving optimal grid stability. Hybrid systems attempt to address these limitations but may introduce additional complexity.

Therefore, there remains a need for a more robust, efficient, and cost-effective solution to manage EV charging and facilitate the integration of renewable energy sources into the power grid.

### SUMMARY

In an exemplary embodiment, a fault management method for an electric power distribution network with integrated intermittent generation is disclosed. The method includes adjusting a plurality of hyperparameters for a first Convolution Neural Network (CNN), a second CNN, and a third CNN, training the first CNN with a first current signal image from a plurality of phasor measuring units (PMUs) in the electric power distribution network during a fault cycle to obtain a trained first CNN for classifying a fault, training the second CNN with a plurality of second signal images from the plurality of PMUs during a pre-fault cycle and a plurality of third signal images from the plurality of PMUs during the fault cycle to obtain a trained second CNN for detecting a fault section, training the third CNN with the plurality of second signal images from the plurality of PMUs during the pre-fault cycle and the plurality of third signal images from the plurality of PMUs during the fault cycle to obtain a trained third CNN for locating a fault location, classifying the fault based on the first CNN, detecting the fault section based on the second CNN, locating the fault location based on the third CNN, and deploying a fault management plan based on the fault, the fault section, and the fault location.

In one aspect of the embodiment, the method step of training the first CNN further includes preprocessing the first current signal image to subtract a first mean RGB value to obtain an adjusted first current signal image. The method further includes feeding the adjusted first current signal image to a first 2D layer of the first CNN to obtain a first 2D output with a plurality of filters, a batch normalization technique, an activation function, and a padding technique. The first 2D output is fed to a first MaxPooling layer of the first CNN to obtain a first MaxPooling layer output. The method further includes repeating the feeding step a first predetermined number of times, flattening the first MaxPooling layer output to obtain a first single vector output in a first fully connected layer of the first CNN, and generating a probability score based on the first single vector output and a first softmax function in a first output layer of the first CNN.

In one aspect of the embodiment, the method step of training the second CNN further includes preprocessing the second and third current signal images to subtract a mean second RGB value to obtain an adjusted second current signal images and an adjusted third current signal images. The step of training further includes feeding the adjusted second and third current signal images to a second 2D layer of the second CNN to obtain a second 2D output with the plurality of filters, the batch normalization technique, the activation function, and the padding technique. The second 2D output is fed to a second MaxPooling layer of the second CNN to obtain a second MaxPooling layer output.

The step of training further includes repeating the feeding the adjusted second and third current signal images a second predetermined number of times, flattening the second MaxPooling layer output to obtain a second single vector output in a second fully connected layer of the second CNN, and feeding the second single vector output to a first plurality of dense layers of the second CNN with the activation function to obtain a first dense output.

The detecting the fault section step further comprises detecting the fault section based on the softmax function in a second output layer of the second CNN.

In one aspect of the embodiment, the step of training the third CNN further includes preprocessing the second and third current signal images to subtract a mean third RGB value to obtain an adjusted fourth current signal images and an adjusted fifth current signal image.

The step of training further includes feeding the adjusted fourth and fifth current signal images to a third 2D layer of the third CNN to obtain a third 2D output with the plurality of filters, the batch normalization technique, the activation function, and the padding technique. The third 2D output is fed to a third MaxPooling layer of the third CNN to obtain a third MaxPooling layer output.

The step of training further includes repeating the feeding step a third predetermined number of times, flattening the third MaxPooling layer output to obtain a third single vector output in a third fully connected layer of the third CNN, and feeding the third single vector output to a second plurality of dense layers of the third CNN with the activation function to obtain a first dense output.

The locating the fault step further comprising locating the fault based on the softmax function in a third output layer of the third CNN.

In one aspect of the embodiment, a number of the plurality of filters increases in successive layers.

In one aspect of the embodiment, the method is performed in absence of a feature extraction technique and a signal processing technique.

In one aspect of the embodiment, the first, second, and third current signal images consist of a plurality of three-phase current signal images.

In one aspect of the embodiment, the adjusting, training the first, second, and third CNN are performed offline and wherein the classifying, detecting, locating, and deploying are performed online.

In another exemplary embodiment of the present disclosure, a system for fault management in an electric power distribution network with integrated intermittent generation is disclosed. The system includes a plurality of phasor measuring units (PMUs), having each PMU of the plurality of PMUs are placed in pre-determined locations in the electric power distribution network, an offline system communicatively connected to the plurality of PMUs configured to execute a first program instruction, an online system communicatively connected to the plurality of PMUs configured to execute a second program instruction, and a control center communicatively connected to the plurality of PMUs, the offline system, and the online system, wherein the control center is configured to control the plurality of PMUs, the offline system, and the online system and to present a fault management plan.

The first program instruction includes adjusting a plurality of hyperparameters for a first Convolution Neural Network (CNN), a second CNN, and a third CNN, training the first CNN with a first current signal image from the plurality of PMUs in the electric power distribution network during a fault cycle to obtain a trained first CNN for classifying a fault, training the second CNN with a plurality of second signal images from the plurality of PMUs during a pre-fault cycle and a plurality of third signal images from the plurality of PMUs during the fault cycle to obtain a trained second CNN for detecting a fault section, and training the third CNN with the plurality of second signal images from the plurality of PMUs during the pre-fault cycle and the plurality of third signal images from the plurality of PMUs during the fault cycle to obtain a trained third CNN for locating a fault location.

The second program instruction includes classifying the fault based on the first CNN, detecting the fault section based on the second CNN, locating the fault location based on the third CNN, and determining and presenting the fault management plan based on the fault, the fault section, and the fault location.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a single-line diagram of the IEEE 13-node test feeder with distributed generation resources, according to certain embodiments.

FIG. 2 illustrates an exemplary experimental setup for the simulation and real-time analysis of a power distribution network, according to certain embodiments.

FIG. 3 illustrates a schematic representation of the fault diagnosis method employing a hierarchical framework of Convolutional Neural Network (CNN) models, according to certain embodiments.

FIG. 4 illustrates the CNN model for fault classification, according to certain embodiments.

FIG. 5 illustrates the CNN2 model configured for fault section identification and for determining the exact fault location, according to certain embodiments.

FIG. 6 illustrates a one-line diagram that represents the fault location and current measurement configuration within a test power distribution system, according to certain embodiments.

FIG. 7A illustrates the current observed at branches 650-632, according to certain embodiments.

FIG. 7B illustrates the current measured at branches 632-645, according to certain embodiments.

FIG. 7C illustrates the current measured at branches 632-671, according to certain embodiments.

FIG. 7D illustrates the current measured at branch 671-692, according to certain embodiments.

FIG. 8 depicts the confusion matrix for the classification of faults by the CNN model, according to certain embodiments.

FIG. 9 illustrates the IEEE-13 bus feeder segmented into eight distinct sections for the purpose of fault section identification within the power distribution network, according to certain embodiments.

FIG. 10 illustrates the IEEE-13 bus feeder segmented into eight distinct sections for the purpose of fault section identification within the power distribution network, according to certain embodiments.

FIG. 11A displays a bar chart representing the accuracy percentages achieved for fault classification and fault section identification tasks, according to certain embodiments.

FIG. 11B depicts a bar chart that illustrates the error percentages for the exact fault location functionality of the CNN model, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a system, device, and method related fault diagnosis framework designed for electric power distribution networks that incorporate intermittent distributed generation (DG). The present disclosure implements deep convolutional neural networks (CNNs) to eliminate the complexity of feature extraction typically required in traditional fault diagnosis methods. The process utilizes modeling a standard distribution network using a real-time digital simulator (RTDS) and integrating uncertainties from DG, load demand, and fault information with probability density functions. Images of three-phase current signals, captured by phasor measuring units (PMUs) during pre-fault and fault conditions, are used to train the CNN models for accurate fault classification, section identification, and fault location. The method emphasizes offline training for model development while ensuring the capability for online real-time fault diagnosis. The present disclosure provides improved accuracy rates and error margins, establishing a robust, adaptable, and highly accurate system for fault management in modern power distribution networks.

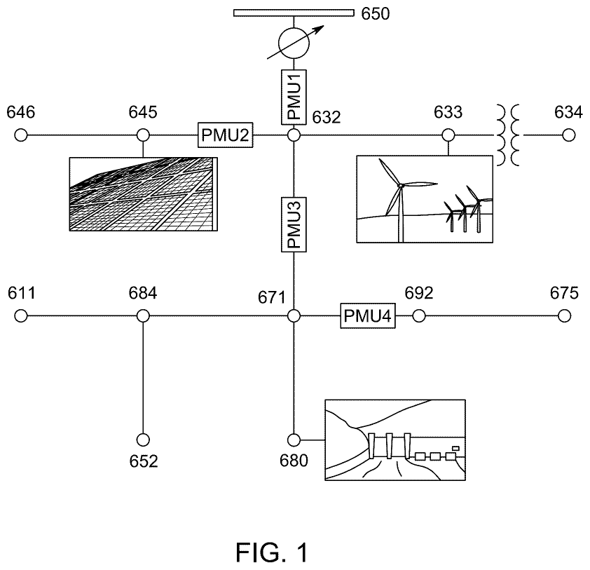

FIG. 1 illustrates a single-line diagram of the IEEE 13-node test feeder with distributed generation resources, in accordance with one embodiment. The IEEE 13-node test feeder, alternatively referred to as a feeder, is configured to evaluate the fault diagnosis methodology. The feeder is a simulation model of a distribution network feeder that consists of 13 buses or nodes interconnected by power lines or cables. The feeder operates at a nominal voltage of 4.16 kV and is designed to emulate the real-life power distribution feeders in a simulated environment. The simulation is performed by considering the distribution network characteristics, such as varying line configurations, multiple load types, and the presence of shunt capacitor banks. The shunt capacitor banks are groups of capacitors that are connected in parallel across the power system at certain buses. The shunt capacitor banks provide reactive power support to the network for managing voltage levels and improving power factor.

The feeder includes a plurality of components that are representative of common elements found in actual power distribution feeders. The plurality of components depicted in FIG. 1 includes a single substation voltage regulator, varied configurations of overhead and underground distribution lines, different load types, and two shunt capacitor banks. The feeder further includes three-phase, two-phase, and single-phase laterals, representing the complexity of Distributed Generation (DG) resource networks.

Distributed Generation (DG) resources, such as wind and photovoltaic (PV) cells, are integrated into the network to simulate the influence of renewable energy sources. DG resources are smaller-scale electricity generation resources that are distributed throughout the power distribution network rather than being centralized. In one implementation, as depicted in FIG. 1, three types of DG sources are represented, hydro, wind, and photovoltaic (solar) generation. The three DG are integrated into the distribution network at different buses and contribute power to the network, influencing its behaviour and fault response.

In one aspect, the hydro resource is a hydroelectric power unit 102 with a capacity of, e.g., 300 kW. Hydroelectric power is characterized as a constant power supplier and provides a steady output regardless of demand variations or system conditions. A wind power generation source is depicted with a 500 kW capacity. Unlike the hydro source, wind generation is intermittent and can be unpredictable. Its variability is typically modelled using probabilistic distributions, such as the Weibull distribution, a model implemented for wind speed and therefore power output. A solar power generation unit is implemented to have a 300 KW capacity at the specific bus. Solar generation is subject to variability due to changes in sunlight conditions, and its output is also modelled using probability distributions to account for this uncertainty.

Referring back to FIG. 1, a hydro-power generation unit with a capacity of 300 kilowatts is positioned at bus 680, a wind power generation unit 104 with a capacity of 500 kilowatts is positioned at bus 633, and a photovoltaic generation unit 106 also with a capacity of 300 kilowatts is positioned at bus 645. The hydroelectric power unit 102 is modelled as a constant power supplier, whereas the wind power generation unit 104 and photovoltaic generation unit 106 are modelled to reflect their stochastic nature using the Weibull probability density function (PDF), capturing the variability in the power output. A PDF function is a statistical term that describes the likelihood of a random variable to take on a given value. In an aspect of the present disclosure, the Weibull PDF is used to model the stochastic nature of wind and solar generation. The PDF function gives a more accurate representation of the variability and randomness associated with renewable energy sources.

In one aspect, the load uncertainties across the network are modelled using a Gaussian probability density function (PDF), consistent with referenced guidelines. The Gaussian PDF is used to represent the uncertainties associated with load demand, reflecting the natural variations and unpredictability of consumer power use. The Gaussian PDF contributes to the simulation by accounting for the natural fluctuations in power demand.

In one aspect of the present disclosure, Phasor Measurement Units (PMUs) are installed at strategic locations within the network to enable accurate and real-time fault diagnosis. A PMU is a device that measures the electrical waves on an electricity grid, using a common time source for synchronization. PMUs measure the voltage and current phasors, the magnitude and phase angle of electrical waves, enabling real-time monitoring and assessment of power systems. The measurements are taken for fault diagnosis as they provide data on the state of the network at the time of a fault.

According to one implementation of the present disclosure, PMUs are installed at the respective buses. Each PMU of the plurality of PMUs are placed in pre-determined locations in the electric power distribution network. PMU1 is located at the intersection of the feeder heads and the substation voltage regulator at bus 632, PMU2 is attached to the branch between bus 632 and bus 645, PMU3 is connected to the branch between bus 632 and bus 671, and PMU4 is located at branch between bus 671 and bus 692. These PMUs are configured for capturing real-time three-phase current signals for the timely and accurate identification and localization of faults within the distribution network.

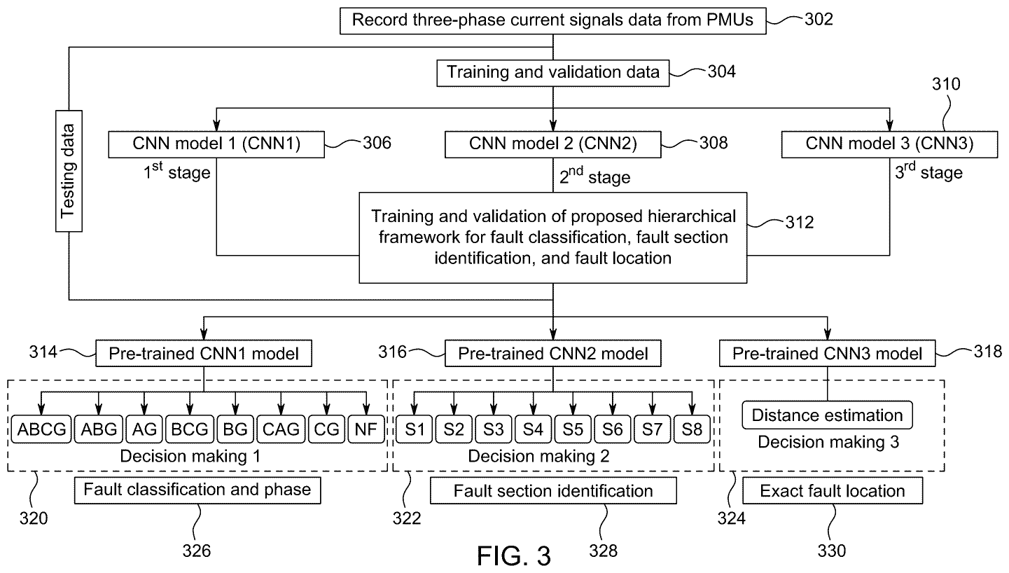

In one aspect, the system includes an offline system communicatively connected to the plurality of PMUs configured to execute a first program instruction. The first program instructions are detailed with reference to FIG. 3.

In one aspect, an online system is communicatively connected to the plurality of PMUs configured to execute a second program instruction. The second program instructions are detailed with reference to FIG. 3.

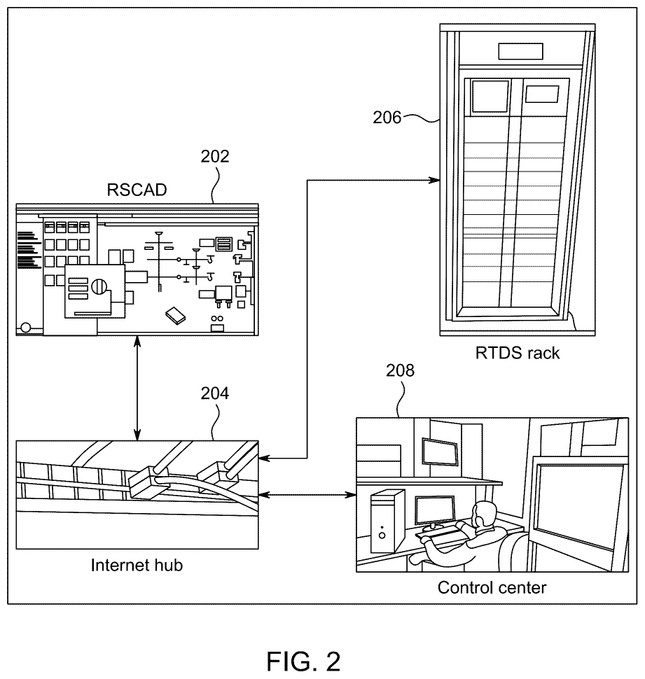

FIG. 2 illustrates an exemplary experimental setup for the simulation and real-time analysis of a power distribution network, specifically the IEEE 13-node test feeder. The setup is configured within a simulation environment. In one example, the simulation environment is R (Real time digital) Simulator Computer Aided Design (RSCAD) environment, interfaced with a Real-Time Digital Simulator (RTDS) for executing the simulations and capturing dynamic responses.

The RSCAD module 202 is the central interface for configuring the simulation parameters and the electrical network's model, including the IEEE 13-node test feeder. The RSCAD environment enables the visualization and manipulation of the network components and facilitates the incorporation of distributed generation resources and various uncertainties.

The Internet hub 204 is configured as a conduit for data exchange, allowing for connectivity and communication between the RSCAD and other components within the setup and monitoring systems.

An RTDS rack 206 is utilized for the real-time simulation of the power network. The RTDS rack contains high-performance processors and I/O interfaces that execute the model developed in RSCAD in real-time.

The Control center 208 is an operational command site where users, such as engineers and technicians, monitor the simulation processes and analyze the results. The control center 208 is equipped with computational and display resources to observe the real-time data provided by the PMUs and other diagnostic equipment. The control center 208 is communicatively connected to the plurality of PMUs, the offline system, and the online system. The control center 208 is configured to control the plurality of PMUs, the offline system, and the online system and to present a fault management plan.

This experimental setup, as illustrated in FIG. 2, replicates fault diagnosis methodology implemented for a power distribution network with the complexities and dynamics of an active system integrated with distributed generation resources.

FIG. 3 illustrates a schematic representation of the fault diagnosis method employing a hierarchical framework of Convolutional Neural Network (CNN) models. The system is based on utilization of a deep CNN to process input data, particularly images, by utilizing multiple layer arrays. The utilization of multiple layer arrays enables the CNN to process spatial and temporal attributes of the data with increased precision, subsequently transforming them into more complex characteristics at reduced resolutions. The structure of a CNN consists of several key layers, including a convolution layer, an activation layer, a pooling layer, and a fully connected layer.

In one aspect, the convolution layer extracts features from image arrays. The convolution layer includes a series of filters or kernels that sweep across the input image, applying their learnable parameters to capture the image's spatial attributes. As these filters move over the image, they perform a dot product operation at each position, maintaining the image's spatial integrity. The convolution action is expressed mathematically as:

$${C}_{j}^{l} = f ( {\sum }_{i ∈ {N}_{j}} {C}_{j}^{l - 1} * {k}_{ij}^{l} + {b}_{j}^{l} )$$

where the operator * represents the convolution operation. Nⱼ is the set of feature maps, l is the current layer, kᵢⱼ^{l} is the convolution kernel of lth layer, b is the network bias. Cⱼ^{l} is the output of l layer and Cⱼ^{l-1} is the output of previous layer l−1 and ƒ(.) is the activation function.

Following each convolution layer, there is an activation layer, introducing non-linearity into the network's operations. The non-linearity allows the CNN to learn complex patterns by applying a non-linear activation function to the output of neurons from previous layers. Common activation functions include ReLU, sigmoid, and tan h, with ReLU defined as:

$$F ( x ) = \{ \begin{matrix}x , x \geq 0 \\ 0 , x < 0\end{matrix}$$

Positioned between consecutive convolution layers, there is the pooling layer which reduces parameter count and dimensionality of data through down sampling. While both max and average pooling exist, max pooling is typically preferred for its effectiveness in preserving vital features. This layer significantly reduces computational complexity and enhances the CNN's efficiency.

The fully connected layer merges extracted features from the convolutional and pooling layers. In this dense network structure, neurons from one layer fully connect to neurons in the next layer, enabling intricate pattern recognition. The final fully connected layer outputs class labels for classification tasks or numerical values for regression analyses.

The method disclosed in FIG. 3 is divided into three distinct stages. First stage is fault classification (306). Second stage is fault section identification 308. Third stage is fault location 310. Each stage is configured with a dedicated CNN mode, first CNN, referred to as CNN1, second CNN, referred to as CNN2, and third CNN, referred to as CNN3, respectively.

The training of CNN1 is performed based on the first program instruction.

The process includes a step of adjusting a plurality of hyperparameters for a first Convolution Neural Network (CNN), a second CNN, and a third CNN

The process further includes a step of the recording of three-phase current signal data from Phasor Measurement Units (PMUs), at step 302. In one example, a plurality of first current signal image, a plurality of second signal images, and a plurality of third signal images are recorded. The first, second, and third current signal images consist of a plurality of three-phase current signal images. The data is recorded for the real-time detection and analysis of faults within the power distribution network. The recorded data is then segmented into two subsets.

At step 314, the process further includes a step of training the first CNN with the plurality of first current signal image from a plurality of PMUs in the electric power distribution network during a fault cycle to obtain a trained first CNN for classifying a fault. First, training and validation data 304, is used to train and validate the CNN models, and second, testing data 306, is used to evaluate the model's predictive capabilities.

At step 316, the process further includes a step of training the second CNN with the plurality of second signal images from the plurality of PMUs during a pre-fault cycle and a plurality of third signal images from the plurality of PMUs during the fault cycle to obtain a trained second CNN for detecting a fault section.

At step 318, the process further includes a step training the third CNN with the plurality of second signal images from the plurality of PMUs during the pre-fault cycle and the plurality of third signal images from the plurality of PMUs during the fault cycle to obtain a trained third CNN for locating a fault location.

Further steps of the method, as described below, are based on the second program instruction.

The decision-making process at step 320 is based on the classification results from CNN1, identifying various fault types, such as three-phase (ABCG), phase-to-phase (ABG), phase-to-ground (AG), and so forth.

The decision-making process at step 322 is based on the classification results from CNN1.

The decision-making process at step 324 is based on the classification results from CNN2.

Upon fault classification and phase determination 326, the pre-trained CNN2 model 316 includes a step of detecting the fault section based on the second CNN. The pre-trained CNN2 model 316 identifies the fault section, at step 328. The decision-making process, at stage 322, involves identifying the specific section of the network where the fault has occurred, with sections designated as S1, S2, through S8.

At third stage 310, the process utilizes the pre-trained CNN3 model 318 configured for locating the fault location based on the third CNN, at step 330. The process involves a regression analysis to determine the precise location of the fault along the distribution line. the Decision-making process, at stage 324, culminates in the identification of the exact fault location, thus completing the fault diagnosis process.

The process then includes a step of deploying a fault management plan based on the fault, the fault section, and the fault location.

In one aspect, the adjusting, training the first, second, and third CNN are performed offline and wherein the classifying, detecting, locating, and deploying are performed online. Each CNN model in the hierarchy is pre-trained using a robust dataset derived from simulated fault scenarios within the power distribution network. Such pre-training equips the models with the capability to perform real-time analysis and fault diagnosis with high accuracy and reliability.

Prior to initiate the training of the model, the hyperparameters are configured accurately. Hyperparameters are distinct from model parameters. The model parameters are learned during training. The hyperparameters require pre-setting to optimal values. Various strategies for hyperparameter optimization have been implemented. Examples of the optimization strategies include, but not limited to, empirical trial-and-error, as well as systematic approaches, such as GridSearchCV and RandomizedSearchCV, which methodically evaluate the model across a range of hyperparameter values to ascertain the most efficacious configuration. According to the present disclosure, a trial-and-error methodology was deemed sufficient for achieving the targeted outcomes, eliminating the need for more complex optimization methods. The specifics of the hyperparameters selected are expounded upon in the ensuing subsections of the disclosure.

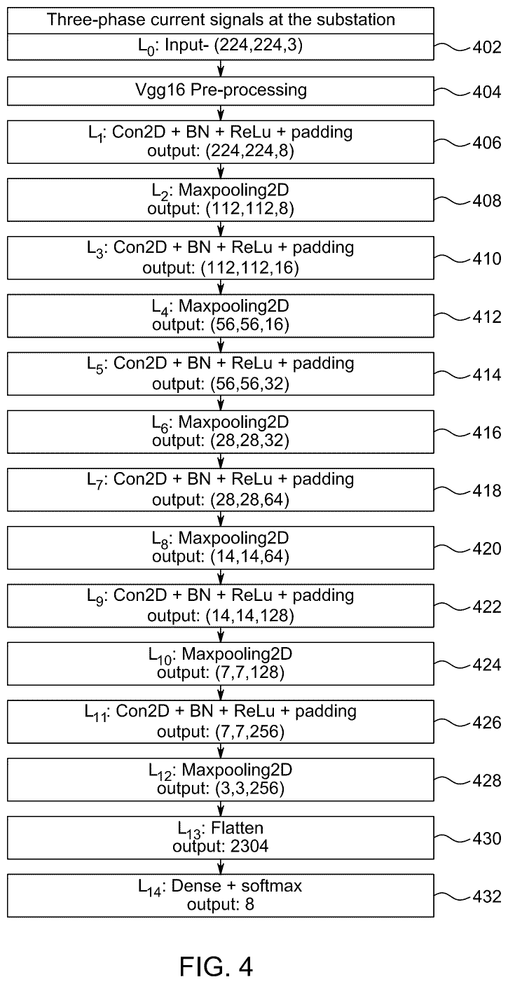

FIG. 4 illustrates the CNN model for fault classification, in accordance with certain embodiment. In one implementation, the CNN model is configured for the classification of electrical faults based on three-phase current signal data. The model is constituted of a succession of layers, each performing a unique operation to contribute to the fault classification process.

The CNN model of one aspect of the present disclosure is structured with fourteen layers, L₁ to L₁₃, where six layers, specifically L₁, L₃, L₅, L₇, and L₉, function as 2D convolution layers as illustrated in FIG. 4. The input for this model is an image that records the tri-phase current signal captured by the PMU1 at the substation during a fault event. The initial pre-processing involves the deduction of the mean RGB value, ascertained from the training dataset, from each pixel in the input image, a method analogous to the one applied in the VGG16 model. This processed image then serves as the input for the CNN model. The input dimension is shaped at 224 by 224 by 3 pixels. The convolution layers automatically delineate features from these input images. To counter potential issues with gradient amplification, batch normalization is applied within each convolution layer to stabilize the inputs across each batch. Additionally, padding is incorporated in these layers to ensure the output's dimensionality aligns with that of the input, thus preserving data integrity. The convolution layers utilize progressively increasing filter counts, 8, 16, 32, 64, 128, and 256, respectively, aided by a 3 by 3 filter size, to effectively draw out increasingly complex features at each layer. The Rectified Linear Unit (ReLU) activation function is employed at these layers.

Subsequent to the convolution layers, Maxpooling layers with a kernel size of 2 by 2 are deployed, serving to down sample the data and highlight the most significant features for the following layers. The fully connected layer, referred to as L₁₃, consolidates the outputs from preceding layers into a singular vector. The concluding layer of the model, L₁₄, corresponds to the output layer, which is comprised of neurons equal to the total count of fault classifications and normal conditions, 8 in total for this specific model. This layer utilizes the softmax function to convert the neural outputs into probabilistic values ranging from 0 to 1 for each category. The softmax function is mathematically articulated as follows:

$${P ( X )}_{i} = \frac{{e}^{{x}_{i}}}{{\sum }_{i = 0}^{j} {e}^{{x}_{j}}} , j ∈ [ 0 , 8 ]$$

where P(X)ᵢ is the probability obtained for i class, x is the output of the previous layer, e is the exponential function, and j is the number of classes. The output class is determined based on the maximum probability score given by:

$${P}_{class} = arg max ( P )$$

Referring back to FIG. 4, the method for configuring CNN1 for fault classification is described. In one aspect, the method is performed in the absence of a feature extraction technique and a signal processing technique.

The Layer Lₒ, at step 402, represents the collection of the input data, consisting of three-phase current signals from the substation. The input data is structured in a matrix form with dimensions 224×224×3, corresponding to the spatial resolution and the three channels of the RGB color space.

Step 404 includes preprocessing the first current signal image to subtract a first mean RGB value to obtain an adjusted first current signal image. The pre-processing operation normalizes each pixel of the input image by deducting the mean RGB value, a computation derived from the training dataset.

Layer L₁, at step 406, includes two-dimensional convolutions (Con2D), Batch Normalization (BN) and the Rectified Linear Unit (ReLU) activation function. Padding is applied to maintain the dimensionality of the output, ensuring the retention of critical information.

Layer L₂, at step 408, includes MaxPooling2D, reducing the spatial dimensions by half while retaining the depth, thereby emphasizing the most salient features and reducing the computational load for subsequent layers.

The CNN model continues with additional convolution layers (L₃, L₅, L₇, L₉, L₁₁), represented by numerals 410, 414, 418, 422, and 426, and MaxPooling layers (L₄, L₅, L₈, L₁₀, L₁₂), represented by numerals 412, 416, 420, 424, and 428, respectively. Each convolution layer increases the number of filters, capturing progressively more complex and abstract features from the input data. Correspondingly, each MaxPooling layer further downsamples the feature maps, streamlining the feature set for efficient processing. A number of the plurality of filters increases in successive layers.

The penultimate layer, L₁₃, at step 430, flattens the output of the previous layer into a one-dimensional vector in preparation for the final classification stage.

Layer L₁₄, at step 432, is a dense layer coupled with a softmax activation function. L₁₄ translates the high-dimensional feature vectors into probability scores for the eight possible fault classes and healthy states within the power distribution network.

The entirety of FIG. 4 illustrates the flow of CNN1 model from input to classification output, detailing the transformations and processing steps that occur at each layer to facilitate the accurate categorization of faults from the electrical signal data.

The CNN training method as described by FIG. 4 is applied on CNN1, CNN2 and CNN3 models to train each model for respective functions.

In one aspect, the step of training CNN1 includes the preprocessing the first current signal image to subtract a first mean RGB value to obtain an adjusted first current signal image. The method further includes feeding the adjusted first current signal image to a first 2D layer of the first CNN to obtain a first 2D output with a plurality of filters, a batch normalization technique, an activation function, and a padding technique. The first 2D output is fed to a first MaxPooling layer of the first CNN to obtain a first MaxPooling layer output. The method further includes repeating the feeding step a first predetermined number of times, flattening the first MaxPooling layer output to obtain a first single vector output in a first fully connected layer of the first CNN, and generating a probability score based on the first single vector output and a first softmax function in a first output layer of the first CNN.

The step of training further includes repeating the feeding of the adjusted second and third current signal images a second predetermined number of times, flattening the second MaxPooling layer output to obtain a second single vector output in a second fully connected layer of the second CNN, and feeding the second single vector output to a first plurality of dense layers of the second CNN with the activation function to obtain a first dense output.

The detecting the fault section step further comprises detecting the fault section based on the softmax function in a second output layer of the second CNN.

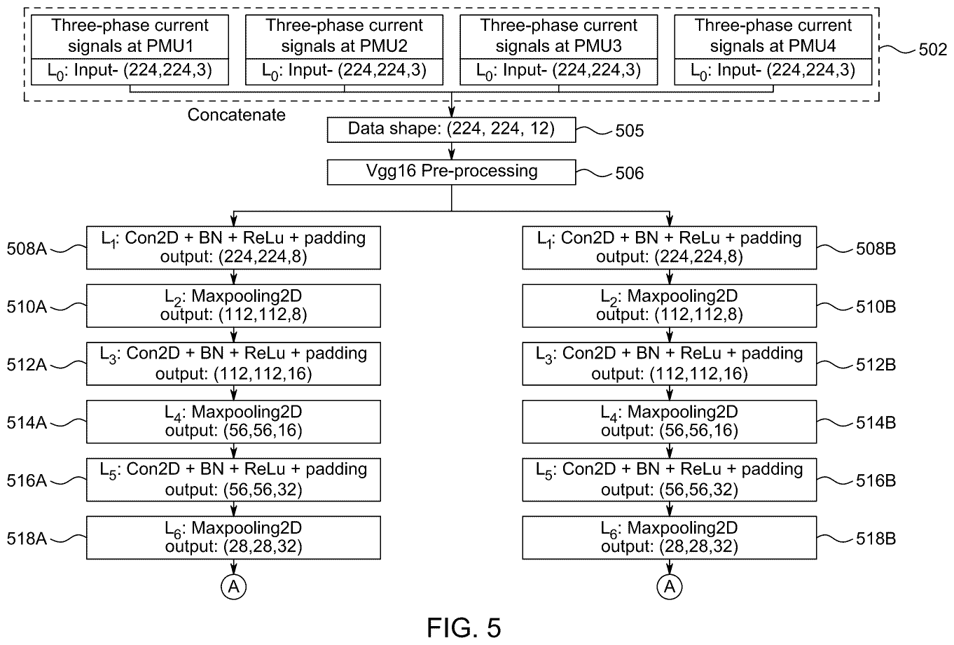

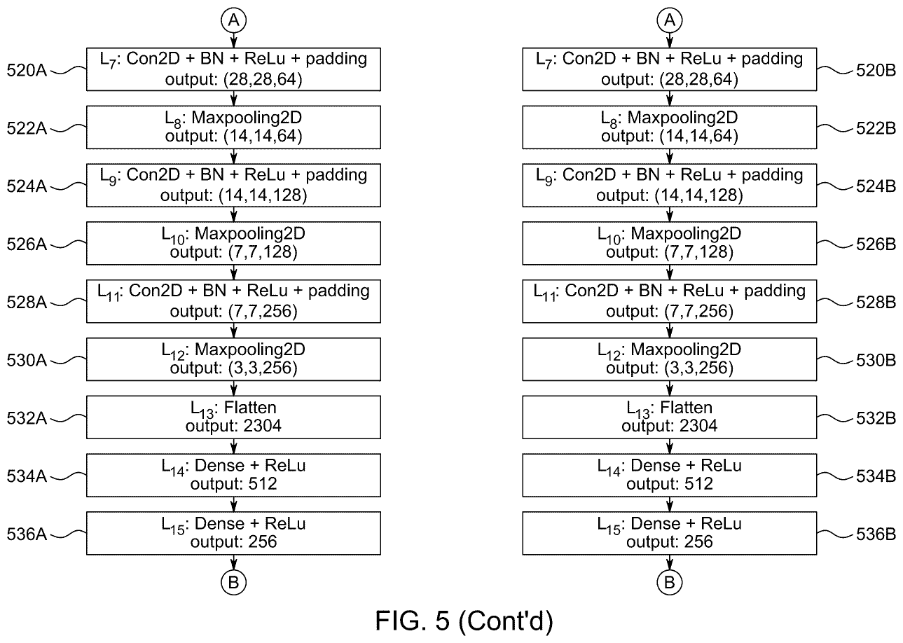

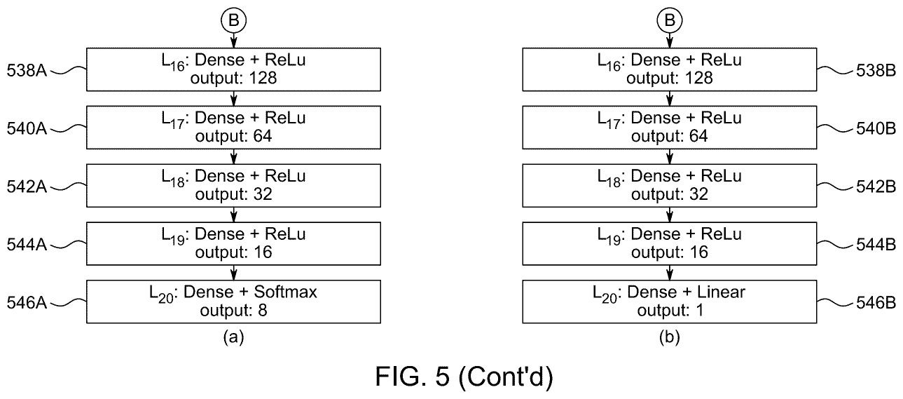

FIG. 5(A) illustrates the CNN2 model configured for fault section identification, in accordance with certain embodiments.

Building upon the foundation laid by CNN1, the CNN2 model includes nineteen layers, L₁ through L₁₉, with six layers dedicatedly configured for two-dimensional convolution. The CNN2 model is based on images representing the three-phase current signal from four distinct PMU locations both before and during a fault. The images, originating from the same fault event, are merged along the channel dimension, resulting in an input shape of 224×224×12 pixels.

The architecture of CNN2 largely mirrors that of CNN1 as depicted in FIG. 4, with the addition of six dense layers post-flattening that employ ReLU activation. Layer L20, serves as the output layer and is proportioned to match the number of fault sections, which is eight. This layer utilizes the softmax function to ascertain the precise fault section, thereby refining the model's fault localization accuracy.

The input, at step 502, is a combination of three-phase current signal images captured at four PMU locations during pre-fault and fault conditions. These images are concatenated along the channel axis to form an input with dimensions 224×224×12, at step 505.

Following the concatenation step, the data undergoes a VGG16 pre-processing routine, at step 506, to normalize the pixel values across the input images. The subsequent convolutional layer, L₁, step 508A, includes Batch Normalization (BN) and Rectified Linear Unit (ReLU) activation, along with padding to preserve data dimensions post-convolution. This pattern is maintained through alternating convolutional (steps 508A, 512A, 516A, 520A, 524A, and 528A) and MaxPooling layers (steps 510A, 514A, 518A, 522A, 526A, and 530A) culminating in layer L₁₃, where the data is flattened, at step 532A.

The flattened output is then subjected to a series of dense layers with ReLU activation (L₁₄ through L₁₉), with each layer successively reducing its dimensionality. The progression is performed at steps 534A to 544A. Layer L₂₀, at step 546A, is a dense layer employing the SoftMax function, which classifies the fault into one of eight possible sections.

The method steps described through FIG. 5(A) are implemented for training the second CNN. In a summary of FIG. 5(A) description, the method includes preprocessing the second and third current signal images to subtract a mean second RGB value to obtain an adjusted second current signal image and an adjusted third current signal images. The step of training further includes feeding the adjusted second and third current signal images to a second 2D layer of the second CNN to obtain a second 2D output with the plurality of filters, the batch normalization technique, the activation function, and the padding technique. The second 2D output is fed to a second MaxPooling layer of the second CNN to obtain a second MaxPooling layer output.

FIG. 5(B) illustrates the CNN3 model configured for determining exact fault location, in accordance with certain embodiments. The CNN3 model is distinct from CNN1 and CNN2 in such a way that CNN3 addresses the task of fault distance estimation, which is inherently a regression problem. The pre-processing and input dimensions remain consistent with CNN2. Given that the objective here is to project a singular fault distance value, the output layer is simplified to a single neuron. For the purpose of regression, a linear activation function is employed in this terminal layer.

The CNN3 model is configured to estimate the exact distance to the fault location, categorizing it as a regression problem. The input pre-processing and shape are consistent with those of the CNN2 model, ensuring uniformity in the data fed into the model.

The architecture of CNN3 progresses through an identical sequence of convolutional and pooling layers as CNN2, at steps 508B through 532B. The output layer L₂₀, at step 546B, implements, a single neuron with a linear activation function, instead of a soft-max classification layer. This neuron outputs a continuous value representing the estimated fault distance, completing the regression task.

The method steps described in FIG. 5(B) are implemented for training the third CNN. In a summary of FIG. 5(B) description, the method includes preprocessing the three phase current signal images from four PMU locations to subtract a mean third RGB value to obtain an adjusted fourth current signal images and an adjusted fifth current signal images, having an input shape of 224×224×12 pixels.

The step of training further includes feeding the adjusted fourth and fifth current signal images to a third 2D layer of the third CNN to obtain a third 2D output with the plurality of filters, the batch normalization technique, the activation function, and the padding technique. The third 2D output is fed to a third MaxPooling layer of the third CNN to obtain a third MaxPooling layer output.

The step of training further includes repeating the feeding step a third predetermined number of times, flattening the third MaxPooling layer output to obtain a third single vector output in a third fully connected layer of the third CNN, and feeding the third single vector output to a second plurality of dense layers of the third CNN with the activation function to obtain a first dense output.

Locating the fault step further comprises locating the fault based on the linear (or softmax) function in a third output layer of the third CNN.

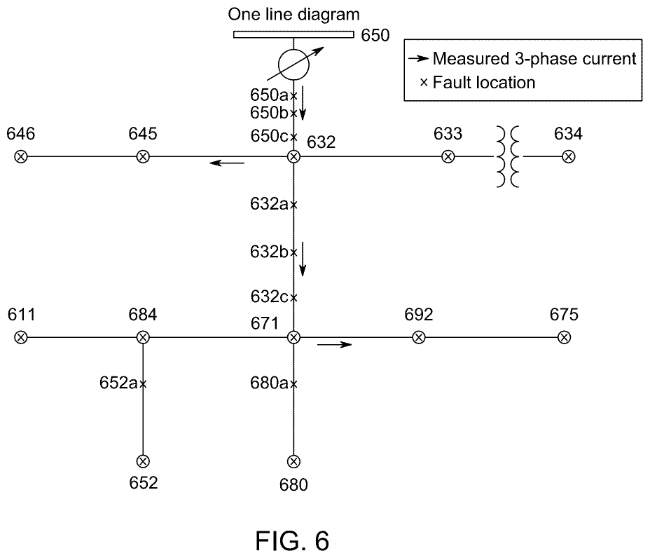

FIG. 6 illustrates a one-line diagram that represents the fault location and current measurement configuration within a test power distribution system, in accordance with certain embodiments. In the present embodiment, seven different fault types are applied, including single-line-to-ground (AG, BG, and CG), double-line-to-ground (ABG, BCG, and ACG), and three-phase-to-ground (ABCG) at 21 random locations as shown in FIG. 6.

The diagram depicts an array of buses, denoted by numerals 611, 632, 633, 634, 645, 646, 671, 675, 680, and 692, which constitute nodes in the test feeder system. Each bus is identified by a unique numerical label corresponding to its position within the network.

At various points in the network, marked by ‘x’ (650a, 650b, and 650c), different fault types are applied to simulate fault conditions. These fault types include single-line-to-ground (AG, BG, CG), double-line-to-ground (ABG, BCG, ACG), and three-phase-to-ground (ABCG). The fault locations are distributed across the network to encompass a comprehensive range of scenarios, as demonstrated by the placement of faults at buses, such as 652a, 632a, 632b, 632c, and 680a.

The simulated fault conditions of the present disclosure incorporate dynamic load conditions, as well as the inherent variability associated with solar and wind power generation. The details of these simulated faults, along with their respective parameters, are cataloged in Table 1. Fault resistance is established through a uniform probability density function (PDF), with selected values spanning from 1 ohm to 50 ohms. Concurrently, the inception angle is determined through a random selection anywhere within a full cycle, which is 0 to 360 degrees. Load variations are factored into the simulations at a range of plus or minus 15 percent, adhering to a uniform PDF. Similarly, the fluctuations in solar irradiation and wind speed are modeled with a Gaussian PDF, allowing for a variance of plus or minus 10 percent from the rated power values. The resultant three-phase current signals, comprising 167 samples per cycle for each fault instance, are acquired from Phasor Measurement Units (PMUs) and are subsequently input into the fault diagnostic model. With four PMUs distributed across the network, a total of twelve signals are yielded from each simulation, thereby amassing critical data pertinent to the fault state.

TABLE 1
Possible fault configurations

| Parameter | Possible scenarios |
|---|---|
| Fault type | AG, BG, CG, ABG, BCG, CAG, and ABCG |
| Fault position | All buses, every 500 ft interval |
| | between buses 650-632 and 632-671, |
| | and 500 ft. between buses 671-680 and 684-652 |
| Fault | 0-50Ω |
| resistance | |

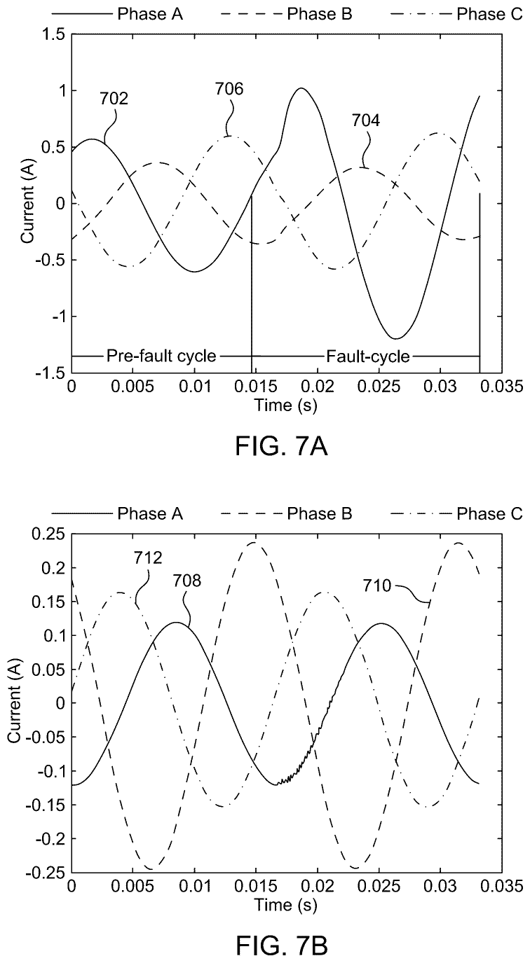

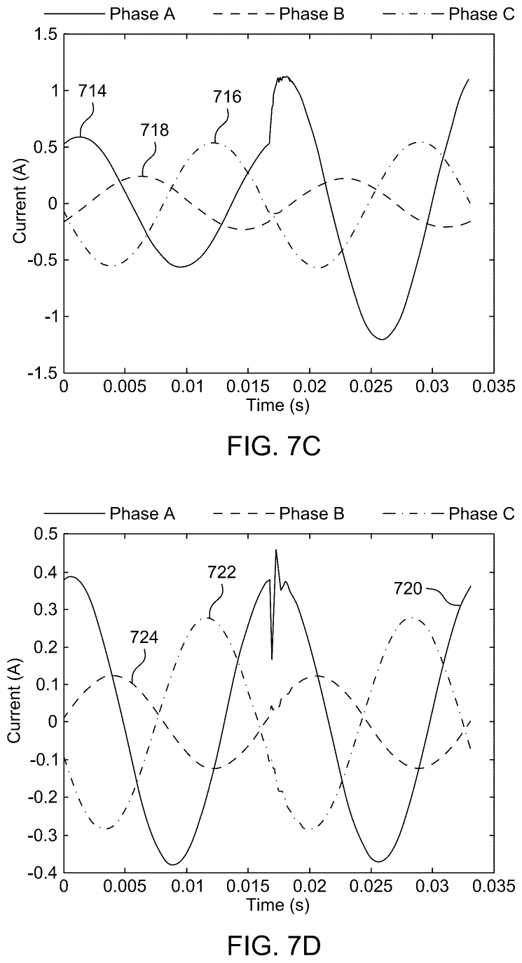

FIG. 7(A) to FIG. 7(D) illustrate a set of graphical illustrations representing the current waveforms observed at various branches within the power distribution network, captured during both pre-fault and fault conditions.

FIG. 7(A) illustrates the current observed at branches 650-632. The waveforms, 702 for Phase A, 704 for Phase B, and 706 for Phase C, exhibit a transition from pre-fault to fault conditions. This transition is characterized by a significant deviation in the waveform pattern during the fault cycle, as illustrated by the arrows.

FIG. 7(B) illustrates the current measured at branches 632-645. The waveforms, 708 for Phase A, 710 for Phase B, and 712 for Phase C, indicate the comparative analysis of current behaviour before and during a fault, as evidenced by the shifts in waveform patterns.

FIG. 7(C) illustrates the current measured at branches 632-671. The respective phase currents are depicted by waveforms 714 for Phase A, 716 for Phase B, and 718 for Phase C. The graphical representation indicates the pre-fault and fault-cycle currents, enabling observation of the electrical parameters' variations due to the fault event.

FIG. 7(D) illustrates the current measured at branches 671-692. Waveforms, 720 for Phase A, 722 for Phase B, and 724 for Phase C are shown. The waveforms demonstrate the discrepancies in current that arise upon the initiation of a fault within the system, as the waveforms distinctly alter in response to the fault.

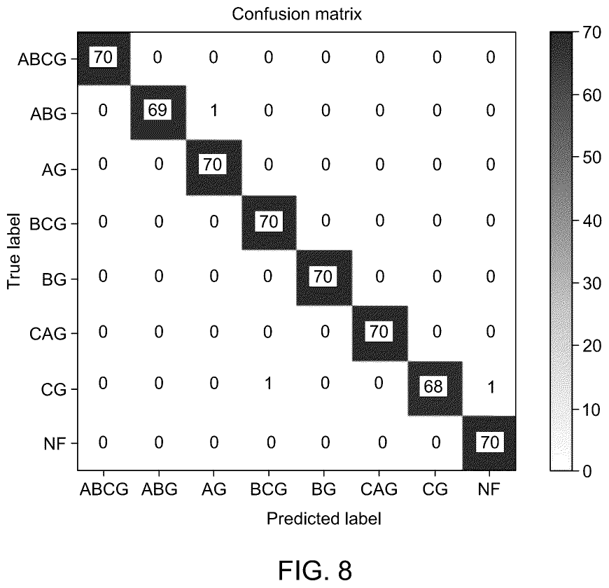

FIG. 8 depicts the confusion matrix for the classification of faults by the CNN model, in accordance with certain embodiments. For classification, the CNN model is trained. In one implementation of the present disclosure, to facilitate the training and validation of the CNN model, a dataset containing 5,600 images was generated. This collection was produced through repeated simulation runs on the RSCAD platform, covering a spectrum of conditions that include various fault types, namely ABCG, ABG, AG, BCG, BG, CAG, and CG, as well as non-fault scenarios (NF). These simulations reflected the variable nature of solar and wind energy outputs, load dynamics, and distinct fault events. The dataset was sourced exclusively from a Phasor Measurement Unit (PMU) stationed at Bus 650 within the substation, which has proven adequate for the precise classification of fault types, negating the need for additional data from other PMUs. For the input to the CNN model, images captured during fault incidents were used. This dataset was randomly divided, allocating 90% for training and 10% for testing, with a subset of the training data (10%) set aside for validation to monitor and prevent overfitting.

The training regimen employed the Adam optimizer, configured with a learning rate of 0.001, and utilized categorical cross-entropy to measure loss. Labels were encoded using a one-hot scheme, for example, [1, 0, 0, 0, 0, 0, 0, 0], indicating that a sample is associated with the first type of fault, with the rest of the array's elements reflecting the absence of the remaining fault types. The training process was conducted with batches of 10 samples over 100 epochs, during which the model's accuracy on the validation set was continually monitored. Improvements in performance led to the model being saved at a specified location. The final selection of the model was based on peak performance metrics achieved on the validation set. The entire sequence of constructing, training, and evaluating the CNN model was executed using the Tensorflow and Keras libraries within the Python 3.9.0 environment. The computational work was carried out on hardware featuring an Apple M1 chip, which is equipped with an 8-core CPU, a 7-core GPU, and 8 GB of RAM.

The efficacy of the CNN model was quantified using metrics such as accuracy, recall, specificity, precision, and the F1-score, whose mathematical formulations are delineated in Table 2. Class-specific results, as outlined in Table 3, indicate the model's capacity to predict fault types with more than 99% accuracy, achieving a weighted average accuracy of 0.9946. An extensive assessment of the model's capability to classify fault types is visually represented by the confusion matrix shown in FIG. 8. It is notable that the CNN model demonstrates a high level of precision in classifying fault types across most instances, with a mere three occurrences of misclassification.

TABLE 2
Different performance matrices

| Performance metric | Mathematical expression |
|---|---|
| Accuracy | TP + FTPP + +TTNN + FN |
| Recall | TP |
| Specificity | TP + FN |
| | TN |
| | TN + FP |
| Precision | $\frac{TP}{TP + FP}$ |
| F1-score | $2 \times \frac{Precision \times Recall}{Precision + Recall}$ |

TABLE 3
Class-wise result of an embodiment

| Class name | | | | | F1-score |
|---|---|---|---|---|---|
| ABCG | | | | | 1.00 |
| ABG | | | | | 0.9928 |
| AG | | | | | 0.9929 |
| BCG | | | | | 0.9929 |
| BG | | | | | 1.00 |
| CAG | | | | | 1.00 |
| CG | | | | | 0.9855 |
| No-Fault | | | | | 0.9929 |
| (NF) | | | | | |
| Weighted | | | | | 0.9946 |
| average | | | | | |
| | Accuracy | Recall | Specificity | Precision | |
| | 1.00 | 1.00 | 1.00 | 1.00 | |
| | 0.9982 | 0.9857 | 1.00 | 1.00 | |
| | 0.9982 | 1.00 | 0.9980 | 0.9859 | |
| | 0.9982 | 1.00 | 0.9980 | 0.9859 | |
| | 1.00 | 1.00 | 1.00 | 1.00 | |
| | 1.00 | 1.00 | 1.00 | 1.00 | |
| | 0.9964 | 0.9714 | 1.00 | 1.00 | |
| | 0.9982 | 1.00 | 0.9980 | 0.9859 | |
| | 0.9946 | 0.9946 | 0.9992 | 0.9946 | |

A confusion matrix is a tabular visualization that enables the comparison of the actual versus predicted classifications of a classification program on which the CNN model is based.

The matrix layout cross-tabulates predictions against the true labels, facilitating an evaluation of instances where the predictions align with the actual fault types, as well as instances of misclassification. The horizontal axis of the matrix represents the predicted fault classes (Predicted label), while the vertical axis represents the actual fault classes (True label). Each cell in the matrix represents the number of samples from the testing set that corresponds to the given actual and predicted fault type pairings.

The fault types included in the matrix are:
ABCG (three-phase-to-ground)
ABG (line-to-line-to-ground)
AG (single-line-to-ground)
BCG (line-to-line-to-ground)
BG (line-to-line-to-ground)
CAG (line-to-line-to-ground)
CG (single-line-to-ground)
NF (no fault)

The leading diagonal cells, corresponding to true positive predictions for each fault type, are highlighted by the model's ability to correctly classify the majority of instances. For example, cell reference numeral 70 indicates that 70 instances of the ABCG fault type were accurately predicted by the model. The non-diagonal cells represent misclassified instances by the model. For instance, a misclassification would be where the model predicts a fault type ABG while the true fault type is AG, this is depicted by the numeral 1 in the respective cell of the matrix.

The color intensity in the confusion matrix corresponds to the frequency of predictions, with darker shades indicating a higher number of predictions for a particular fault type. This visualization succinctly demonstrates the model's proficiency in fault classification, with a clear aggregation of correct classifications along the matrix's diagonal and minimal off-diagonal entries, denoting few misclassifications.

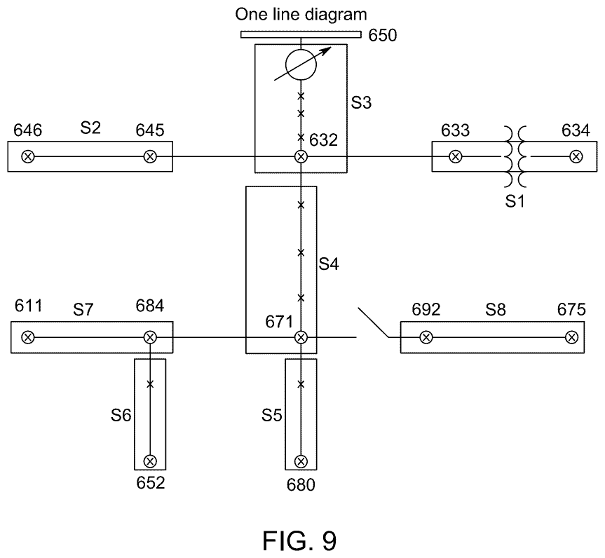

FIG. 9 illustrates the IEEE-13 bus feeder segmented into eight distinct sections for the purpose of fault section identification within the power distribution network, in accordance with certain embodiments. This diagram serves as a foundational layout for the subsequent fault localization process executed by the CNN model.

Subsequent to fault type classification, the subsequent objective is to localize the section of the fault. For this purpose, the distribution feeder is segmented into eight sections, depicted in FIG. 9. Within each segment, faults are simulated, and the resultant three-phase current signals are captured by four Phasor Measurement Units (PMUs). From each PMU location, a collection of 200 instances of fault conditions is created, yielding four signals per fault case. This culminates in an accumulation of 800 images for every fault location, amounting to a total dataset of 6400 images (800 images per location multiplied by the 8 locations) which are processed by the CNN model. This dataset is then randomly allocated into two subsets: 90% for training and the remaining 10% for testing. Additionally, a tenth of the training subset is earmarked for validation to track and mitigate the risk of model overfitting. Training of the model is conducted using the Adam optimization algorithm with a set learning rate of 0.001, and the classification is refined using categorical cross-entropy as the loss function. The training regimen is consistent, with a batch size maintained at 10 and the total number of training cycles (epochs) capped at 100. The model variant demonstrating the peak accuracy on the validation set is preserved as the definitive model.

As shown in FIG. 9, each section of the feeder, S1, S2, S3, S4, S5, S6, S7, and S8, indicates the division of the network into segments where potential faults can be isolated. For instance, section S1 includes buses 633 and 634, while section S4 includes bus 671. The individual sections are depicted as bounded areas within the diagram, providing a visual demarcation of the test system's segmentation.

The buses within the system, corresponding to nodes in the feeder, are identified by numerals 611, 632, 634, 645, 646, 671, 675, 680, 684, and 692. These numerals serve as precise location markers for the various components and intersecting points of the distribution network.

The one-line diagram simplifies the complex structure of the power distribution network into an intelligible format, elucidating the areas where faults are simulated and the current measurements are taken. The visual representation in FIG. 9 is critical for understanding how the power system is analysed during fault diagnosis procedures and for interpreting the distribution of fault locations within the network.

By partitioning the feeder into clearly defined sections, the diagram facilitates targeted investigations of fault incidents, allowing the CNN model to efficiently discern the specific section of the network experiencing a fault. Such a structured flow enhances the accuracy of the fault diagnosis system by correlating observed electrical disturbances with the precise sections of the distribution feeder.

Table 4 shows the section-wise result of the system of the present disclosure. The disclosed CNN model is able to identify the fault section with more than 0.99 accuracy.

TABLE 4

| Section | | | | | F1-score |
|---|---|---|---|---|---|
| S1 | | | | | 0.9756 |
| S2 | | | | | 0.9744 |
| S3 | | | | | 1.00 |
| S4 | | | | | 1.00 |
| S5 | | | | | 1.00 |
| S6 | | | | | 1.00 |
| S7 | | | | | 1.00 |
| S8 | | | | | 1.00 |
| Weighted | | | | | 0.9938 |
| average | | | | | |
| | Accuracy | Recall | Specificity | Precision | |
| | 0.9938 | 1.00 | 0.9929 | 0.9524 | |
| | 0.9938 | 0.95 | 1.00 | 1.00 | |
| | 1.00 | 1.00 | 1.00 | 1.00 | |
| | 1.00 | 1.00 | 1.00 | 1.00 | |
| | 1.00 | 1.00 | 1.00 | 1.00 | |
| | 1.00 | 1.00 | 1.00 | 1.00 | |
| | 1.00 | 1.00 | 1.00 | 1.00 | |
| | 1.00 | 1.00 | 1.00 | 1.00 | |
| | 0.9938 | 0.9938 | 0.9991 | 0.9938 | |

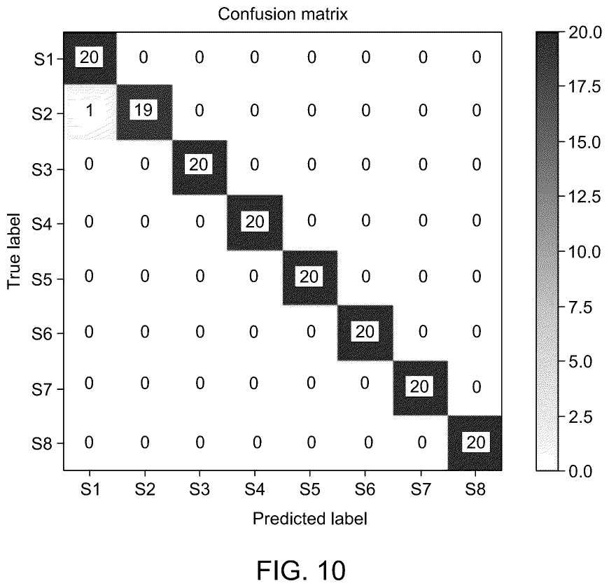

FIG. 10 depicts a confusion matrix that is utilized to evaluate the performance of the CNN model in identifying fault sections within a power distribution network, in accordance with certain embodiments. The confusion matrix is implemented in the field of machine learning and diagnostics, providing a comprehensive perspective on the classification accuracy of the CNN model.

The matrix is structured in a grid format where the vertical axis, True label, corresponds to the actual fault sections ranging from S1 to S8 within the feeder. Conversely, the horizontal axis, the Predicted label, corresponds to the CNN model's predictions for these fault sections.

Each cell within the matrix corresponds to the intersection of the predicted and actual sections, with the cell values indicating the count of predictions for each scenario. The leading diagonal cells, which are notably populated with higher values, reflect correct predictions where the model's forecasted fault section aligns with the actual fault section.

For example, the matrix indicates that for section S1, the model correctly identified 20 instances as belonging to this section, while it misclassified 1 instance that actually pertained to section S2. This misclassification is indicated by the number 1 in the cell that intersects the predicted label S1 with the true label S2.

The colour gradient of the matrix, which darkens in correspondence to higher values, visually underscores the concentration of accurate predictions along the diagonal, thereby signifying the model's precision in section identification. The matrix conveys a high degree of accuracy in the model's predictions, with most sections being correctly identified, and only a singular instance of misidentification.

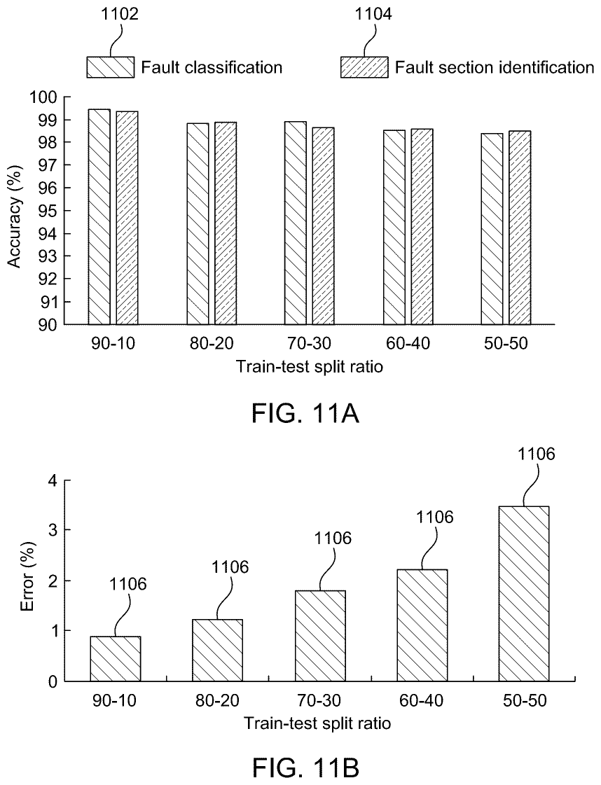

FIG. 11 exhibits the performance metrics of CNN models as a function of different train-test data split ratios, facilitating an evaluation of the models' effectiveness across varying conditions of data availability.

FIG. 11A displays a bar chart representing the accuracy percentages achieved for fault classification and fault section identification tasks, in accordance with certain embodiments. Each pair of bars correlates to a specific partitioning of the dataset into training and testing sets, ranging from a 90-10 split to an equitable 50-50 split. The fault classification bar is numbered as 1102. The fault section identification bar is numbered as 1104. This visual comparison underscores the models' capability to maintain high accuracy levels, proving the resilience even when the availability of training data is halved.

FIG. 11B, depicts a bar chart that illustrates the error percentages for the exact fault location functionality of the CNN model. Train-test split ratio bars indicating an exact fault location is numbered as 1106. As shown in the graph, the increase in error percentages as the training data diminishes emphasizes the importance of sufficient data for the training process, while still highlighting the robustness of the model given its consistently low error rates.

Following the classification of faults and identification of the faulted section, the ensuing procedure involves ascertaining the precise distance of the fault from the substation. This task is approached as a regression analysis. As depicted in FIG. 5, faults are simulated at twenty-one disparate locations selected at random. Notably, even if different fault sites are equidistant from the substation, the estimation of the fault location is contingent on the previously determined fault section, which precludes redundant estimations. For every specified location, a series of 200 fault instances is generated. From each fault instance, four current signal readings are acquired from four strategically positioned PMUs, aggregating to a total of 800 images for each location. The aggregate dataset, therefore, encompasses 16,800 images (800 images per location times 21 locations), which are utilized as inputs for the CNN model. The division of this dataset is executed at random, allocating 90% for model training and the remaining 10% for model testing. Within the training portion, a subdivision of 10% is reserved for validation to ensure the model is not overfitting. Model training employs the Adam optimization algorithm with a learning rate set at 0.001, and the training regimen comprises a fixed batch size of 10 over a span of 100 epochs. The application of the CNN model is evaluated using performance indicators such as the mean absolute error (MAE), the root mean square error (RMSE), and the standard error. These metrics are formulated mathematically to provide a quantifiable measure of the model's performance accuracy. The mathematical expression:

$$M A E = \frac{1}{{N}_{s}} {\sum }_{n = 1}^{{N}_{s}} ( \vert {L}_{t} - \tilde{{L}_{t}} \vert ) \\ RMS E = \sqrt{\frac{1}{{N}_{s}} {\sum }_{n = 1}^{{N}_{s}} {( \vert {L}_{t} - \tilde{{L}_{t}} \vert )}^{2}} \\ Error ( \% ) = \frac{\vert {L}_{t} - \tilde{{L}_{t}} \vert}{L} \times 100$$

where Nₛ is the number of samples, Lₜ is the predicted distance in km of the t^{th} sample, \tilde{L}ₜ is the actual distance in km of the t^{th} sample, and L is the total length of the branch in km. The disclosed model achieves good accuracy in pinpointing the exact fault location, yielding an error of 0.9%, mean absolute error (MAE) of 0.013, and root mean square error (RMSE) of 0.03. The power distribution feeder may encounter contingencies such as a branch outage. For the purposes of the present disclosure, the outage of branches 633-634 is taken into account, and the performance of the disclosed model is evaluated against this specific contingency. As indicated in Table 5, the model's efficacy in fault diagnosis is tested across five arbitrary test cases under the condition of a single branch outage. The results demonstrate that the model consistently and accurately identifies both the type of fault and its location in all tested scenarios.

Additionally, contingencies in renewable energy generation are considered. Specifically, photovoltaic (PV) generation ceases under no sunlight conditions, while wind generation halts if wind speeds are outside the operational range, above the cutoff speed, and below the cut-in speed. Fault diagnosis performance under these conditions of PV and wind plant outages is documented in Table 6 and Table 7, respectively, for a set of ten random cases. The results predominantly indicate the model's accurate fault diagnosis capability despite these contingencies.

Furthermore, the method and system of the present disclosure are compared with conventional fault diagnosis approaches. A notable observation is that many conventional methods do not perform comprehensive fault diagnosis, which includes fault classification and phase, section identification, and location. Some require feature extraction as an integral step, and only a few takes into account the impact of distributed generations (DGs) on fault diagnosis. An exhaustive comparison of the method and system of the present disclosure with conventional techniques is provided in Table 8, emphasizing a balanced and fair evaluation.

The comparison reveals that several conventional methods necessitate voltage and current measurements at all nodes and do not consider the influence of DGs and load fluctuations on fault diagnosis. Moreover, none execute all three tasks—fault classification, section identification, and location—that are encompassed in the present disclosure. The comparative analysis underscores the merits of the method and system of the present disclosure, which include more efficient data usage and the incorporation of factors such as DGs, load variations, fault resistance, and specific fault locations, coupled with real-time data procurement. While the precision of the presently disclosed method and system might marginally lag behind some conventional methods, the presently disclosed method deals with a higher complexity level due to its thorough coverage of all potential fault scenarios.

TABLE 5
Fault diagnosis under a branch outage

| | | Actual fault | Predicted |
|---|---|---|---|
| No. | Item | information | results |
| 1 | Fault location | 650c | — |
| | Fault type | ABCG | ABCG |
| | Fault section | S3 | S3 |
| | Location (ft.) | 1500 | 1497.7 |
| | Error (%) | — | 0.046 |
| 2 | Fault location | 632 | — |
| | Fault type | CAG | CAG |
| | Fault section | S3 | S3 |
| | Location (ft.) | 2000 | 2000.32 |
| | Error (%) | — | 0.0064 |
| 3 | Fault location | 680 | — |
| | Fault type | ABG | ABG |
| | Fault section | S5 | S5 |
| | Location (ft.) | 5000 | 4995.40 |
| | Error (%) | — | 0.092 |
| 4 | Fault location | 671 | — |
| | Fault type | CAG | CAG |
| | Fault section | S4 | S4 |
| | Location (ft.) | 4000 | 3854 |
| | Error (%) | — | 0.0292 |
| 4 | Fault location | 650a | — |
| | Fault type | AG | AG |
| | Fault section | S3 | S3 |
| | Location (ft.) | 500 | 505.25 |
| | Error (%) | — | 0.001 |

TABLE 6
Fault diagnosis under PV outage

| | | Actual fault | Predicted |
|---|---|---|---|
| No. | Item | information | results |
| 1 | Fault location | 633 | — |
| | Fault type | ABCG | ABCG |
| | Fault section | S1 | S1 |
| | Location (ft.) | 1000 | 991.47 |
| | Error (%) | — | 0.34 |
| 2 | Fault location | 684 | — |
| | Fault type | AG | AG |
| | Fault section | S7 | S7 |
| | Location (ft.) | 4300 | 4325 |
| | Error (%) | — | 0.54 |
| 3 | Fault location | 692 | — |
| | Fault type | ABG | ABG |
| | Fault section | S8 | S8 |
| | Location (ft.) | 4000 | 4065.21 |
| | Error (%) | — | 1.44 |
| 4 | Fault location | 611 | — |
| | Fault type | CAG | CAG |
| | Fault section | S7 | S6 * |
| | Location (ft). | 4600 | 5105 |
| | Error (%) | — | 10.97 * |
| 5 | Fault location | 650 | — |
| | Fault type | AG | AG |
| | Fault section | S3 | S3 |

TABLE 8
Comparison with existing methods

| Characteristics | | | | | PM |
|---|---|---|---|---|---|
| Network type | | | | | Radial/loop |
| Method | | | | | CNN |
| Data type | | | | | Current |
| DG | | | | | PV, wind, |
| | | | | | and hydro |
| Load | | | | | Yes |
| fluctuation | | | | | |
| Feature | | | | | Automatic |
| extraction | | | | | |
| No. of | | | | | Limited |
| measurements | | | | | nodes |
| Complexity | | | | | High |
| Functionalities | | | | | FTP, FSI, |
| | | | | | and EFL |
| Real-time | | | | | RTDS |
| simulation | | | | | |
| Results | | | | | 99.46% in |
| | | | | | FTP, |
| | | | | | 99.38% in |
| | | | | | FSI, and |
| | | | | | 0.9% error |
| | | | | | in EFL |
| | [1] | [2] | [3] | [4] | |
| | Radial/loop | Radial | Radial | Radial | |
| | CNN | CNN | GCN | Capsule | |
| | | | | CNN | |
| | Voltage | Voltage | Current | Voltage | |
| | and | and | | | |
| | current | current | | | |
| | PV | No | No | No | |

| Yes | No | Yes | No |
|---|---|---|---|
| Automatic | Automatic | Automatic | STFS |
| All nodes | All nodes | All nodes | At the substation |
| High | Low | Normal | Low |
| FTP | FT and FSI | EFL | FSI and EFL |
| No | No | No | No |
| 99.88% | 99.9% accuracy | 99.26% | 99.9% accuracy in FSI |
| in FTP | in FT and FSI | in EFL | and 0.26% error in EFL |

The present disclosure presents a robust and intelligent hierarchical fault diagnosis framework for the power distribution grid that takes into account various uncertainties, including those associated with renewable energy generation, demand loads, and fault characteristics. Employing the IEEE 13-node standard distribution feeder, which integrates solar PV, wind, and hydropower as distributed generators, the model accommodates the variability in generation through suitable probability density functions. The efficacy of the framework is validated through a multitude of performance metrics such as accuracy, recall, specificity, precision, and F1-score. The methodology also tackles the estimation of fault distance, assessed using metrics like mean absolute error, root mean square error, and error percentage. Outcomes demonstrate that the framework attains high metric scores, surpassing 0.99 in weighted average for classification tasks and showcasing a 0.9% error rate for fault distance estimation, indicative of its precision in fault localization.

It is noted that even with a reduced data training set, the framework maintains over 98% accuracy in classification tasks. However, the accuracy dips slightly in fault location tasks with less training data, resulting in a 3.47% error rate, which remains within acceptable limits for such analyses. The framework's potential extension to scenarios involving concurrent faults and various voltage-level grids is also disclosed. Further research directions could investigate the implications of lower sampling frequency and waveform distortion and apply the method to larger distribution networks through transfer learning.

Numerous modifications and variations of the present disclosure are possible in light of the above teachings. It is therefore to be understood that within the scope of the appended claims, the invention may be practiced otherwise than as specifically described herein.

1. A fault management method in an electric power distribution network with integrated intermittent generation, comprising:
adjusting a plurality of hyperparameters for a first Convolution Neural Network (CNN), a second CNN, and a third CNN;
training the first CNN with a first current signal image from a plurality of phasor measuring units (PMUs) in the electric power distribution network during a fault cycle to obtain a trained first CNN for classifying a fault;
training the second CNN with a plurality of second signal images from the plurality of PMUs during a pre-fault cycle and a plurality of third signal images from the plurality of PMUs during the fault cycle to obtain a trained second CNN for detecting a fault section;
training the third CNN with the plurality of second signal images from the plurality of PMUs during the pre-fault cycle and the plurality of third signal images from the plurality of PMUs during the fault cycle to obtain a trained third CNN for locating a fault location;
classifying the fault based on the first CNN;
detecting the fault section based on the second CNN;
locating the fault location based on the third CNN; and
deploying a fault management plan based on the fault, the fault section, and the fault location.

2. The method of claim 1, wherein the training the first CNN further comprises:
preprocessing the first current signal image to subtract a first mean RGB value to obtain an adjusted first current signal image;
feeding the adjusted first current signal image to a first 2D layer of the first CNN to obtain a first 2D output with a plurality of filters, a batch normalization technique, an activation function, and a padding technique, wherein the first 2D output is fed to a first MaxPooling layer of the first CNN to obtain a first MaxPooling layer output;
repeating the feeding step a first predetermined number of times;
flattening the first MaxPooling layer output to obtain a first single vector output in a first fully connected layer of the first CNN; and
generating a probability score based on the first single vector output and a first softmax function in a first output layer of the first CNN.

3. The method of claim 2, wherein the training the second CNN further comprises:
preprocessing the second and third current signal images to subtract a mean second RGB value to obtain an adjusted second current signal images and an adjusted third current signal images;
feeding the adjusted second and third current signal images to a second 2D layer of the second CNN to obtain a second 2D output with the plurality of filters, the batch normalization technique, the activation function, and the padding technique, wherein the second 2D output is fed to a second MaxPooling layer of the second CNN to obtain a second MaxPooling layer output;
repeating the feeding the adjusted second and third current signal images a second predetermined number of times;
flattening the second MaxPooling layer output to obtain a second single vector output in a second fully connected layer of the second CNN; and
feeding the second single vector output to a first plurality of dense layers of the second CNN with the activation function to obtain a first dense output; and
wherein the detecting the fault section step further comprises detecting the fault section based on the first softmax function in a second output layer of the second CNN.

4. The method of claim 3, wherein the training the third CNN further comprises:
preprocessing the second and third current signal images to subtract a mean third RGB value to obtain an adjusted fourth current signal images and an adjusted fifth current signal images;
feeding the adjusted fourth and fifth current signal images to a third 2D layer of the third CNN to obtain a third 2D output with the plurality of filters, the batch normalization technique, the activation function, and the padding technique, wherein the third 2D output is fed to a third MaxPooling layer of the third CNN to obtain a third MaxPooling layer output;
repeating the feeding step a third predetermined number of times;
flattening the third MaxPooling layer output to obtain a third single vector output in a third fully connected layer of the third CNN; and
feeding the third single vector output to a second plurality of dense layers of the third CNN with the activation function to obtain a first dense output; and
wherein the locating the fault step further comprising locating the fault based on a linear function in a third output layer of the third CNN.

5. The method of claim 4, wherein a number of the plurality of filters increases in successive layers.

6. The method of claim 5, wherein the method is performed in absence of a feature extraction technique and a signal processing technique.

7. The method of claim 5, wherein the first, second, and third current signal images consist of a plurality of three-phase current signal images.

8. The method of claim 1, wherein the adjusting, training the first, second, and third CNN are performed offline and wherein the classifying, detecting, locating, and deploying are performed online.

9. A system for fault management in an electric power distribution network with integrated intermittent generation, comprising:
a plurality of phasor measuring units (PMUs), wherein each PMU of the plurality of PMUs are placed in pre-determined locations in the electric power distribution network;
an offline system communicatively connected to the plurality of PMUs configured to execute a first program instruction;
an online system communicatively connected to the plurality of PMUs configured to execute a second program instruction; and
a control center communicatively connected to the plurality of PMUs, the offline system, and the online system, wherein the control center is configured to control the plurality of PMUs, the offline system, and the online system and to present a fault management plan;
wherein the first program instruction comprises:
adjusting a plurality of hyperparameters for a first Convolution Neural Network (CNN), a second CNN, and a third CNN;
training the first CNN with a first current signal image from the plurality of PMUs in the electric power distribution network during a fault cycle to obtain a trained first CNN for classifying a fault;
training the second CNN with a plurality of second signal images from the plurality of PMUs during a pre-fault cycle and a plurality of third signal images from the plurality of PMUs during the fault cycle to obtain a trained second CNN for detecting a fault section;
training the third CNN with the plurality of second signal images from the plurality of PMUs during the pre-fault cycle and the plurality of third signal images from the plurality of PMUs during the fault cycle to obtain a trained third CNN for locating a fault location; and
wherein the second program instruction comprises:
classifying the fault based on the first CNN;
detecting the fault section based on the second CNN;
locating the fault location based on the third CNN; and
determining and presenting the fault management plan based on the fault, the fault section, and the fault location.

10. The system of claim 9, wherein the training the first CNN further comprises:
preprocessing the first current signal image to subtract a first mean RGB value to obtain an adjusted first current signal image;
feeding the adjusted first current signal image to a first 2D layer of the first CNN to obtain a first 2D output with a plurality of filters, a batch normalization technique, an activation function, and a padding technique, wherein the first 2D output is fed to a first MaxPooling layer of the first CNN to obtain a first MaxPooling layer output;
repeating the feeding step a first predetermined number of times;
flattening the first MaxPooling layer output to obtain a first single vector output in a first fully connected layer of the first CNN; and
generating a probability score based on the first single vector output and a first softmax function in a first output layer of the first CNN.

11. The system of claim 10, wherein the training the second CNN further comprises:
preprocessing the second and third current signal images to subtract a mean second RGB value to obtain an adjusted second current signal images and an adjusted third current signal images;
feeding the adjusted second and third current signal images to a second 2D layer of the second CNN to obtain a second 2D output with the plurality of filters, the batch normalization technique, the activation function, and the padding technique, wherein the second 2D output is fed to a second MaxPooling layer of the second CNN to obtain a second MaxPooling layer output;
repeating the feeding the adjusted second and third current signal images a second predetermined number of times;
flattening the second MaxPooling layer output to obtain a second single vector output in a second fully connected layer of the second CNN; and
feeding the second single vector output to a first plurality of dense layers of the second CNN with the activation function to obtain a first dense output; and
wherein the detecting the fault section step further comprises detecting the fault section based on a linear function in a second output layer of the second CNN.

12. The system of claim 11, wherein the training the third CNN further comprises:
preprocessing the second and third current signal images to subtract a mean third RGB value to obtain an adjusted fourth current signal images and an adjusted fifth current signal images;
feeding the adjusted fourth and fifth current signal images to a third 2D layer of the third CNN to obtain a third 2D output with the plurality of filters, the batch normalization technique, the activation function, and the padding technique, wherein the third 2D output is fed to a third MaxPooling layer of the third CNN to obtain a third MaxPooling layer output;
repeating the feeding step a third predetermined number of times;
flattening the third MaxPooling layer output to obtain a third single vector output in a third fully connected layer of the third CNN; and
feeding the third single vector output to a second plurality of dense layers of the third CNN with the activation function to obtain a first dense output; and
wherein the locating the fault step further comprising locating the fault based on the linear function in a third output layer of the third CNN.

13. The system of claim 12, wherein a number of the plurality of filters increases in successive layers.

14. The system of claim 12, wherein the method is performed in absence of a feature extraction technique and a signal processing technique.

15. The system of claim 12, wherein the first, second, and third current signal images consist of a plurality of three-phase current signal images.
